(19) United States
(12) Patent Application Publication
(10) Pub. No.: US 2026/0164259 A1
(43) Pub. Date: Jun. 11, 2026

(54) METHODS AND SYSTEMS FOR AI/ML-BASED ANALOG CHANNEL STATE INFORMATION FEEDBACK REPORTING

(71) Applicant: InterDigital Patent Holdings, Inc., Wilmington, DE (US)

(72) Inventors: Mohamed Amine Arfaoui, Montreal (CA); Philip Pietraski, Jericho, NY (US); Guodong Zhang, Woodbury, NY (US); Asil Koc, Verdun (CA); John Kaewell, Jamison, PA (US)

(73) Assignee: InterDigital Patent Holdings, Inc., Wilmington, DE (US)

(21) Appl. No.: 18/970,346

(22) Filed: Dec. 5, 2024

(51) Int. Cl. H04W 24/02; H04L 5/00; H04W 8/22

(52) U.S. Cl. CPC H04W 24/02; H04L 5/0051; H04W 8/22

(57) ABSTRACT

A wireless transmit/receive unit (WTRU) may determine an artificial intelligence/machine learning (AI/ML) model. The AI/ML model may be associated with channel state information (CSI) feedback function. The WTRU may receive configuration information. The configuration information may include an indication of downlink reference signals. The WTRU may generate one or more latent representations using the AI/ML model, for example based on the downlink reference signals. The WTRU may map the one or more latent representations to uplink resource elements (REs), for example without performing one or more of quantization, forward error correction, and/or modulation. The WTRU may determine one or more scaling factors. The WTRU may transmit an indication of the one or more latent representations, for example using the one or more scaling factors.

### BACKGROUND

Artificial intelligence (AI) may include behavior exhibited by machines that, for example may mimic cognitive functions to sense, reason, adapt, and/or act. An AI component may include the realization of behaviors and/or conformance to requirements by learning based on data, for example without explicit configuration of sequence of steps of actions. An AI component may enable learning complex behaviors. Complex behaviors may be difficult to specify and/or implement when using legacy methods.

Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing a sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may include a class of ML algorithms that may employ artificial neural networks, for example Deep Neural Networks (DNNs). DNNs may be (e.g., loosely) inspired by biological systems. The DNNs may be a special class of ML models that may be inspired by the human brain. The input may be linearly transformed and/or pass through non-linear activation function multiple times. DNNs may include multiple layers. A (e.g., each) layer may include a linear transformation and/or a given non-linear activation function. The DNNs may be trained using the training data, for example via back-propagation algorithm. DNNs may be utilized in a variety of domains including, for example speech, vision, natural language, wireless communication, and/or etc., and/or for (e.g., various) ML settings, for example supervised, un-supervised, semi-supervised, and/or etc.

### SUMMARY

A wireless transmit/receive unit (WTRU) may determine an artificial intelligence/machine learning (AI/ML) model. The AI/ML model may be associated with channel state information (CSI) feedback, for example a CSI feedback function. The WTRU may receive configuration information, for example from a network. The configuration information may include an indication of downlink reference signals. Additionally, or alternatively, the configuration information may include an indication of a size of latent variables for a (e.g., each) latent representation. For example, the size may include a number of latent variables (e.g., for each latent representation). The WTRU may generate one or more latent representations using the AI/ML model, for example based on the downlink reference signals. The WTRU may map the one or more latent representations to uplink resource elements (REs), for example without performing one or more of quantization, forward error correction, and/or modulation. The WTRU may determine one or more scaling factors. The WTRU may transmit an indication of the one or more latent representations, for example using the one or more scaling factors. The WTRU may transmit the indication of the one or more latent representations to the network.

The indication of the one or more latent representations may include one or more respective latent variables associated with the one or more latent representations. For example, the WTRU may transmit the one or more latent representations and/or latent variables. The WTRU may apply the one or more scaling factors to the uplink REs and/or to the one or more latent representations. The WTRU may apply the one or more scaling factors to the one or more uplink REs mapped to the one or more latent representations, for example to scale the latent representations. The WTRU may transmit the one or more scaling factors, for example the value(s) of one or more scaling factors. The WTRU may transmit the one or more scaling factors to the network. The WTRU may determine a pattern. The pattern may include an indication of uplink RE mapping. The WTRU may map the one or more latent representations to the one or more uplink REs, for example based on the indication of uplink RE mapping. The WTRU may receive a message, for example from a network, requesting an indication of an AI/ML capability associated with CSI feedback. For example, the AI/ML capability may be associated with a CSI function. The WTRU may transmit a message, for example to the network, indicating the indication of the AI/ML capability of the WTRU associated with CSI feedback.

The WTRU may receive an indication of an offset from a network. The offset may be a configured offset. The WTRU may determine the one or more scaling factors relative to the offset. The WTRU may determine a value associated with the one or more uplink REs. The value may include a maximum value, a minimum value, an average value, average power value, or a variance value. The WTRU may determine the one or more scaling factors based on the value associated with the one or more uplink REs. The WTRU may determine a power associated with the uplink REs, for example mapped to the one or more latent representations. The WTRU may determine the one or more scaling factors based on the power (e.g., associated with the uplink REs). The WTRU may determine the one or more scaling factors, for example to normalize the WTRU's transmitted signal to unitary power. The WTRU may measure at least one of an uplink channel reference signal and/or a downlink channel reference signal. The WTRU may determine the one or more scaling factors based on at least one of the measured uplink channel reference signal and/or the measured downlink channel reference signal.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of a digital CSI feedback reporting mechanism.

FIG. 3 is an example of an analog CSI feedback reporting mechanism.

FIG. 4 is an example CsiNet model architecture.

FIG. 5 is an example of an analog CSI feedback report mapping to UL REs in a resource block.

FIG. 6 is a flowchart depicting an example of WTRU AI/ML-based analog CSI feedback reporting.

FIG. 7 is a plot of example throughput performance of analog CSI feedback reporting for case 2 spatial/temporal/frequency (STF) CSI compression.

FIG. 8 is a plot of example throughput performance of analog CSI feedback reporting for case 4 STF CSI compression.

### DETAILED DESCRIPTION

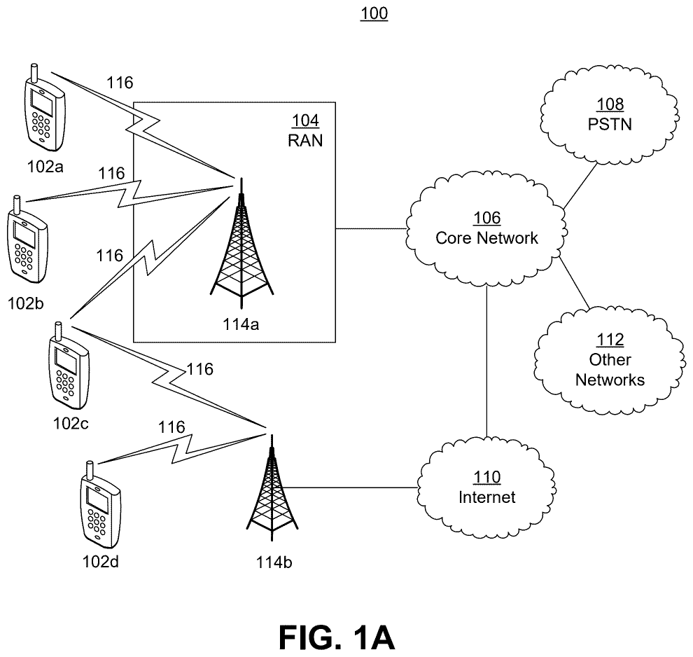

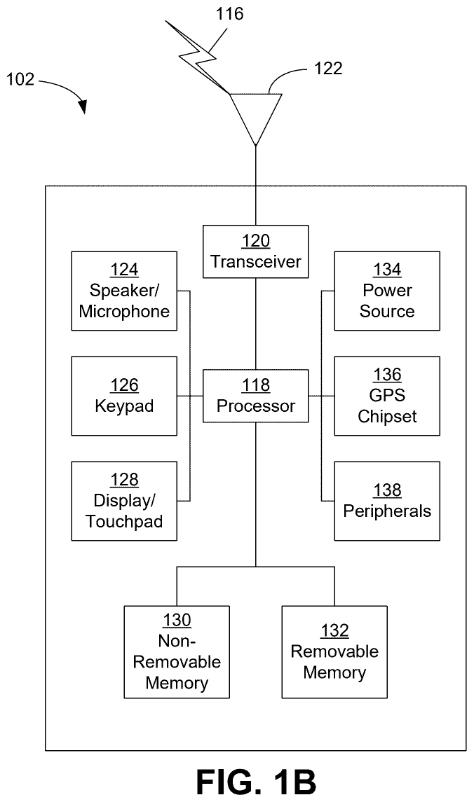

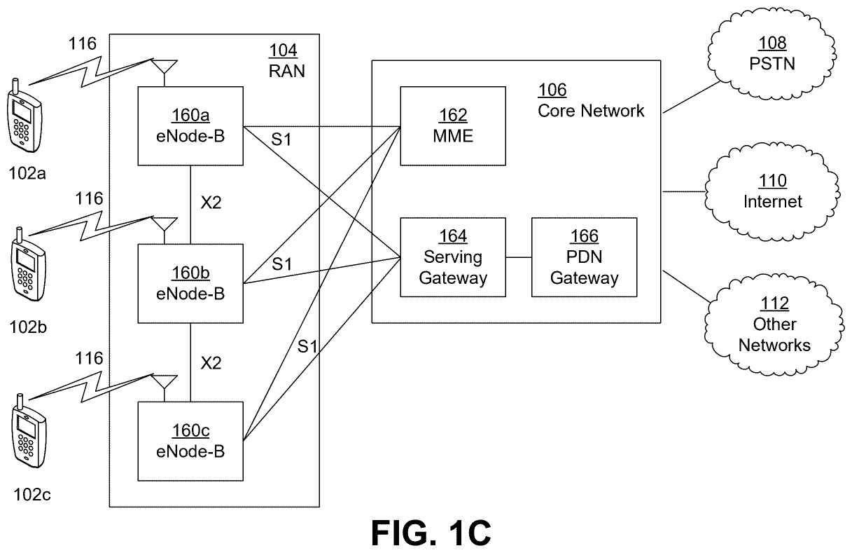

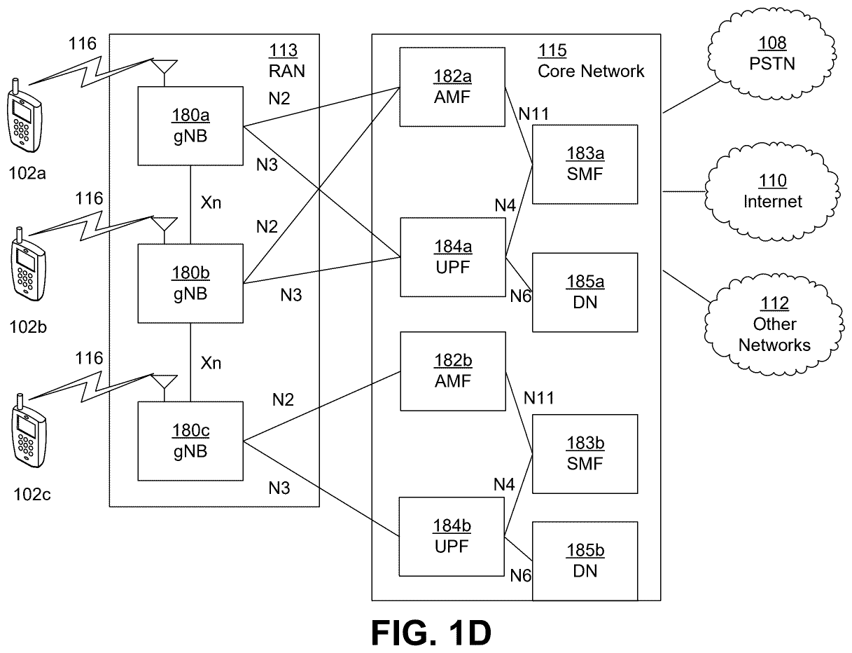

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods are disclosed for a WTRU to enable adaptive filtering techniques for CSI feedback reporting, for example for systems and methods which use AI/ML models for channel state feedback (CSF) functions.

Artificial intelligence (AI) may include behavior exhibited by machines that, for example may mimic cognitive functions to sense, reason, adapt, and/or act. An AI component may include the realization of behaviors and/or conformance to requirements by learning based on data, for example without explicit configuration of sequence of steps of actions. An AI component may enable learning complex behaviors. Complex behaviors may be difficult to specify and/or implement when using legacy methods.

Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may include a class of ML algorithms that may employ artificial neural networks, for example Deep Neural Networks (DNNs). DNNs may be (e.g., loosely) inspired by biological systems. The DNNs may be a special class of ML models that may be inspired by the human brain. The input may be linearly transformed and/or pass through non-linear activation function multiple times. DNNs may include multiple layers. A (e.g., each) layer may include a linear transformation and/or a given non-linear activation function. The DNNs may be trained using the training data, for example via back-propagation algorithm. DNNs may be utilized in a variety of domains including, for example speech, vision, natural language, wireless communication, and/or etc., and/or for (e.g., various) ML settings, for example supervised, un-supervised, semi-supervised, and/or etc.

Auto-encoders (AE) may be a class of deep neural networks (DNNs) that arise in an un-supervised machine learning setting, for example where high-dimensional data is non-linearly transformed to a lower dimensional latent vector using the DNN based encoder. Additionally, or alternatively, a lower dimensional latent vector may (e.g., then) be used to reconstruct the high-dimensional data using a non-linear decoder. The encoder may be represented as E (x; Wₑ) where x is the high-dimensional data and We represents the parameters of the encoder. The decoder may be represented as D (z; W_{d}) where z is the low-dimensional latent representation and W_{d} represents the parameters of the decoder. The auto-encoder may be trained, for example using training data {x₁, . . . , x_{N}}. The auto-encoder may be trained by solving the following example optimization problem:

$$\{ {W}_{e}^{t r} , {W}_{d}^{t r} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above example problem may be approximately solved, for example using a backpropagation algorithm. The trained encoder

$$E ( x ; {W}_{e}^{t r} )$$

may be used to compress the high-dimensional data, and trained decoder

$$D ( z ; {W}_{d}^{t r} )$$

can be used to reconstructs the high-dimensional data from the latent representation.

Channel state feedback (CSF) functions may define a series of functions, for example implemented at the WTRU. The CSF functions may enable estimation of the CSI and/or transmission to a network (NW). The NW may exploit the received CSI feedback to apply link adaptation functions to the WTRU. Example link adaptation functions may include one or more of appropriate MCS and precoding, beam management, power allocation, and/or RB allocation, etc. The CSF functions may include CSI estimation. For example, the WTRU may generate a CSI report containing one or more measurement indicators of the channel quality. The measurement indicators may include one or more of CQI, PMI, RI, and/or LI, etc. CSF functions may be additionally, or alternatively include CSI prediction, CSI compression, and/or combinations of these functions.

Spatial/frequency (SF) CSI compression may include an operation of compressing the CSI estimates in the SF domain by the WTRU (e.g., using AEs), for example to a quantized-binary representation with a predefined feedback size (e.g., in bits). The WTRU may (e.g., then) transmit the feedback to the NW. The NW may (e.g., then) reconstruct the SF CSI estimates by decompressing the received CSI feedback from the WTRU.

Temporal CSI prediction may include an operation of predicting posterior SF CSI, by the WTRU and/or by the NW, for example from historical SF CSI estimates. Sub-use cases may be within the CSF functions and/or may be implemented after the CSI estimation function.

Spatial/temporal/frequency (STF) CSI compression may include an operation of generating a quantized-binary representation of the CSI, for example with a predefined feedback size (e.g., in bits), based on the current and the prior SF CSI estimates. The WTRU may (e.g., then) transmit the feedback to the NW. The NW may (e.g., then) reconstruct the current SF CSI estimates, for example by jointly incorporating the reconstructed prior SF CSI estimates and the received CSI feedback from the WTRU.

CSI compression plus prediction may include operation of concatenating the SF/STF CSI compression and the temporal CSI prediction operation in a cascaded manner. The order of concatenation (e.g., compression first or prediction first) may be interchangeable.

Joint CSI compression and prediction may include an operation of jointly performing CSI compression and prediction within a function block, for example a single function block. Joint CSI compression and prediction may include an operation of generating a quantized-binary representation of the CSI, for example with a predefined feedback size (e.g., in bits), based on the current and/or the prior SF CSI estimates. The WTRU may (e.g., then) transmit the feedback to the NW. The NW may (e.g., then) reconstruct the posterior SF CSI estimates, for example by jointly incorporating the reconstructed prior SF CSI estimates and the received CSI feedback from the WTRU.

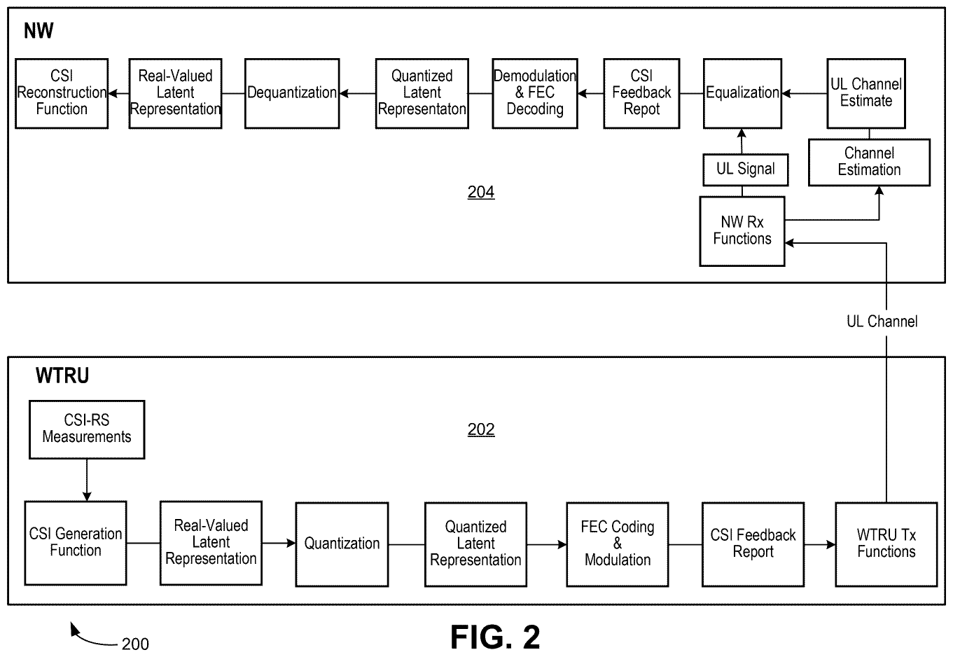

There may be digital CSI feedback reporting for AI/ML-based CSI feedback functions. Conventional AI/ML solutions for CSI feedback enhancement proposed in the literature (e.g. CSI compression) may rely on digital CSI feedback reporting. FIG. 2 is an example of a digital CSI feedback reporting mechanism 200, for example for AI/ML-based CSI feedback functions. A WTRU 202 may perform (e.g., first) measurements on reference signals (RS), for example CSI-RS measurements. The WTRU 202 may input the measurements to an AI/ML-based CSI generation function (e.g., encoder), for example to generate a real-valued latent representation. A latent representation may be a set and/or a vector of one or more latent variables associated with an AI/ML model, for example containing an abstract and/or compressed form of input data that captures one or more of essential features, important features, and/or patterns in the input data. The latent representation (e.g., in an AI/ML model) may be generated by an encoder, for example of an autoencoder. The latent representation may be a compressed and/or lower-dimensional abstraction of input data. The latent representation may serve as an intermediary for a decoder to reconstruct original data and/or enable efficient processing while preserving key information and uncovering hidden patterns.

The WTRU 202 may apply quantization to the real-valued latent representation to generate a quantized latent representation. The WTRU 202 may (e.g., then) apply forward error correction (FEC) coding and/or modulation to the resulting quantized latent representation, for example to construct a digital CSI feedback report. The WTRU 202 may (e.g., then) use a (e.g., specific) UL precoder to the resulting digital CSI feedback report. The WTRU 202 may map the resulting digital CSI feedback report to the UL resource elements and transmit it to a NW 204.

The NW 204 may receive the UL signals and/or estimate the UL channel. The NW 204 may (e.g., then) apply equalization to the UL signals, for example using the estimated UL channel. The NW 204 may extract the digital CSI feedback report from the equalized received UL signals. The NW 204 may apply one or more of demodulation, FEC decoding, and/or dequantization to the extracted digital CSI feedback report, for example in order to recover the real-valued latent representation generated by the WTRU 202 AI/ML-based CSI generation function (e.g., encoder). The NW 204 may input the recovered real-valued latent representation to an AI/ML-based CSI reconstruction function (e.g., decoder), for example to reconstruct the DL CSI (or the associated DL precoder).

AI/ML solutions for CSI feedback enhancement proposed in the technical literature (e.g. CSI compression) may rely on coded digital CSI feedback reporting. Due to this, these solutions may face several limitations. For example, these solutions may be prone to quantization-induced errors. Transmitting the digital CSI feedback report may incur high signaling overhead, for example when the WTRU uses a low MCS to transmit the quantized latent representation. The digital signal processing (DSP) operation for handling the real-valued latent representation, such as quantization, FEC, modulation, CRC attachment, etc., may add significant complexity at the WTRU and/or the NW. Solutions that enable a more efficient CSI feedback reporting for AI/ML-based CSI feedback functions is desirable.

Systems and method for AI/ML-based analog CSI feedback reporting are disclosed herein. Certain classes of messages may include CSI feedback reports. The certain classes of messages may tolerate small errors in reception, for example since such small errors may induce only small errors in the overall CSI feedback reporting and/or DL precoding mechanisms.

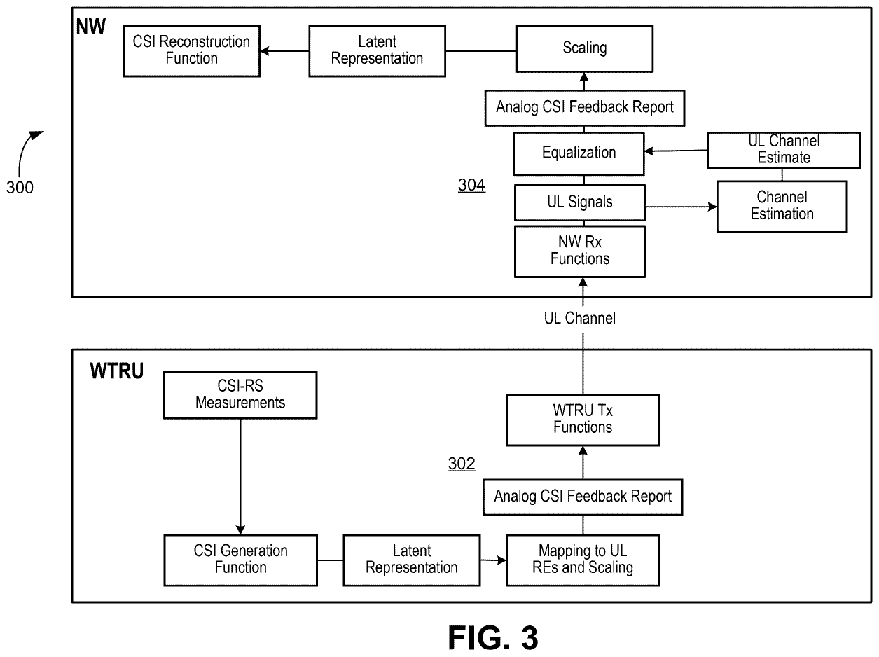

A WTRU may be in analog CSI feedback mode. For example, the NW may switch the WTRU into an analog CSI feedback mode. FIG. 3 is an example of an analog CSI feedback reporting mechanism, for example for AI/ML-based CSI feedback functions. A WTRU 302 and/or a NW 304 may be enabled to use an AI/ML-based analog CSI feedback reporting mechanism. The WTRU 302 may collect DL data and/or perform CSI measurements, for example to estimate properties of the DL channel, (e.g., DL channel estimate, preferred DL precoder). The WTRU 302 may (e.g., then) uses the DL CSI estimate as input to an AI/ML-based CSI generation function (e.g., encoder) and/or output a latent representation (e.g., a vector of real-valued latent variables). The WTRU 302 may map the generated latent representation to UL REs, for example by bypassing one or more of quantization, FEC, and/or modulation. Bypassing the one or more of quantization, FEC, and/or modulation may refer to mapping the one or more latent representations to UL REs without performing one or more of quantization, FEC, and/or modulation. The latent variables in the latent representation may not have fixed amplitudes, for example such that desired uplink power and/or SNR may not be achieved without scaling the latent variables.

The WTRU 302 may compute one or more scaling factors. The WTRU 302 may apply the one or more scaling factors to the UL REs and/or the latent representations, for example such that the UL transmitted signal reaches a target power, for example unitary power. The WTRU 302 may apply the one or more scaling factors to the UL REs mapped to the one or more latent representations, for example to scale the latent representations. The WTRU 302 may determine the one or more scaling factors based on one or more of a metric from the UL REs and/or the latent variables (e.g., max value, min value, average, average power, variance, etc.), a metric from the UL REs and/or latent variables assigned to the same OFDM symbol, a maximum UL transmit power of the WTRU 302, UL/DL channel measurements, and/or an offset. For example, the one or more scaling factors may be computed relative to a configured offset. The configured offset may be received from the NW 304. The WTRU 302 may determine a power associated with the UL REs, for example mapped to the one or more latent representations. The WTRU may determine the one or more scaling factors based on the power (e.g., associated with the UL REs), for example for normalizing a UL transmitted signal to unitary power.

The WTRU 302 may apply the scaling either before or after mapping the generated one or more latent representations to the UL REs. The WTRU 302 may (e.g., then) transmit the mapped and scaled latent representation(s), for example along with the computed one or more scaling factors, to the NW 304. The WTRU 302 may include the computed one or more scaling factors in the analog CSI feedback report, for example so that the NW 304 may undo the scaling and recover the latent representation.

The NW 304 may receive the UL signals carrying the analog CSI feedback report. The NW 304 may extract the latent representation and/or the one or more scaling factors. The one or more scaling factors may include one or more scaling factors. The NW 304 may estimate the UL channel and/or apply equalization to the extracted latent representation, which for example may (e.g., now) include noise. The NW 304 may (e.g., then) undo the scaling using the extracted one or more scaling factors and/or recover the latent representation. The NW 304 may (e.g., then) use the recovered latent representation as input to an AI/ML-based CSI reconstruction function (e.g., decoder), for example to reconstruct the DL CSI estimate. In some examples, the NW 304 may not apply the equalization of the extracted latent representation. The NW 304 may determine to feed the latent representation extracted from the analog CSI feedback report directly, for example without equalization, to the AI/ML-based CSI reconstruction function.

Systems and methods for analog CSI feedback reporting are described herein. The NW as herein may refer to any node in the network, for example one or more of a gNB, and/or another WTRU (e.g., Sidelink, WTRU-to-WTRU direct communication), etc. A WTRU may receive (e.g., from NW) a request to transmit AI/ML-based analog CSI feedback reporting capabilities. The WTRU may transmit the WTRU AI/ML-based analog CSI feedback reporting capabilities, for example to the NW. The WTRU may transmit the WTRU AI/ML-based analog CSI feedback reporting capabilities in a capabilities message. The capabilities message may indicate one or more WTRU capabilities. Example capabilities may include one or more of WTRU support for AI/ML-based analog CSI feedback reporting and/or WTRU hardware/radio impairments. Example WTRU hardware/radio impairments may include phase noise characteristic, and/or power amplifier characteristic, etc., The WTRU may transmit its capabilities to the NW by RRC signaling.

The WTRU may receive (e.g., from NW) an AI/ML model for an AI/ML-based CSI generation function. The WTRU may receive (e.g., from NW) a configuration message, for example including configuration information. The configuration message (e.g., configuration information) may include an indication of downlink reference signals. Additionally, or alternatively, the configuration message (e.g., configuration information) may include (e.g., an indication of) DL RS (e.g., CSI-RS) resource allocation. The DL RS (e.g., CSI-RS) resource allocation may include one or more of RS periodicity, RS locations, and/or RS density, etc. The configuration message may include a CSI feedback reporting configuration. The CSI feedback reporting configuration may include one or more of a reporting type (e.g., periodic, semi-persistent, and/or aperiodic), a report quantity (e.g., configuration of AI/ML-based analog CSI feedback report), a configuration of channel state feedback parameters (e.g., the number of CSI estimates used for CSI feedback reporting, etc.), the size of the analog CSI feedback report and/or the latent representation (e.g., number of latent variables per latent representation), an indication of UL MIMO layers that should be used to transmit the latent representations (e.g., if the WTRU is capable of multi-layer UL transmission), an allocation(s) of the UL resources and/or the signals that should be used to transmit the analog CSI feedback report (e.g., REs pattern over the frequency and/or time domain), and/or one or more mechanisms for mapping (e.g., how to map) the latent representations and/or the scaling factors to the UL REs (e.g., a function that maps the latent representations and the scaling factors to the UL REs). For example, the configuration information may include an indication of a size of a (e.g., each) latent representation. The size may include a number of latent variables for a (e.g., each) latent representation. The signals that should be used to transmit the analog CSI feedback report may include one or more of PUSCH, PUCCH, RRC, UCI, and/or MAC-CE. The WTRU may receive the configuration through one or more of DCI, MAC-CE, and/or RRC signaling.

The WTRU may generate one or more latent representations (e.g., real-valued latent representations), for example using (e.g., based on) DL RS measurements. The WTRU may use the AI/ML model to generate the one or more latent representations. For example, the WTRU may input one or more DL RS measurements to an AI/ML-based CSI generation function and/or generate one or more latent representations. The WTRU may map the generated one or more latent representations, for example without coding and digital modulation, to the allocated UL REs. The WTRU may spread the UL REs carrying the one or more latent representations following a specific pattern. The pattern may be configured by the NW and/or determined by the WTRU. For example, the WTRU may indicate (e.g., to the NW) the REs carrying the one or more latent representations. The WTRU may map the one or more latent representations to the one or more UL REs based on the UL RE mapping (e.g., an indication of the UL RE mapping).

The WTRU may compute one or more scaling factors. The WTRU may determine the one or more scaling factors based on one or more of a metric from the one or more UL REs and/or latent variables (e.g., max value, min value, average, average power, variance, etc.), a metric from one or more UL REs and/or latent variables assigned to the same OFDM symbol, relative to a configured offset (e.g., received from the NW), the WTRU's UL transmit power, and/or UL/DL channel measurements. For example, the one or more scaling factors may be computed relative to an offset (e.g., configured offset) (e.g., from the NW). The one or more scaling factors may be one or more scaling factors.

The WTRU may apply one or more scaling factors to one or more UL REs and/or variables of each latent representation. The WTRU may apply the scaling either before or after mapping the generated one or more latent representations to the allocated UL REs. The WTRU may transmit one or more of the mapped and scaled latent representations to the NW. The WTRU may transmit the value(s) of computed one or more scaling factors to the NW. The WTRU may transmit the value(s) of computed one or more scaling factors to the NW by one or more of a digital transmission (e.g., with FEC and modulation), an analog transmission, and/or manipulation of UL RS (e.g., DMRS).

The NW may transmit an AI/ML-based analog CSI feedback reporting capabilities request to the WTRU. The NW may receive the AI/ML-based analog CSI feedback reporting capabilities from the WTRU. The NW may determine and/or transmit the appropriate AI/ML model for the AI/ML-based CSI generation function to the WTRU. The NW may transmit a configuration message (e.g., configuration information) to the WTRU. The NW may receive the UL signals carrying the analog CSI feedback report. The NW may extract the one or more latent representations from the received analog CSI feedback report. The NW may perform channel estimation and/or apply equalization to the extracted one or more latent representations. The NW may extract the one or more scaling factors from the received analog CSI feedback report. The NW may undo the scaling and/or recover the one or more latent representations. The NW may use the recovered one or more latent representations as input to its AI/ML-based CSI reconstruction function and/or generate a NW-side reconstructed DL CSI estimate.

Systems and method for AI/ML-based analog CSI feedback reporting are disclosed herein. Certain classes of messages may include CSI feedback report(s). The certain classes of messages may tolerate small errors in reception, for example since such small errors may induce only small errors in the overall CSI feedback reporting and/or DL precoding mechanisms. The NW may switch the WTRU into an analog CSI feedback mode. The WTRU and/or the NW may be enabled to use an AI/ML-based analog CSI feedback reporting mechanism. For example, the WTRU may collect DL data and/or perform CSI measurements to estimate properties of the DL channel, (e.g., DL channel estimate, preferred DL precoder). The WTRU may (e.g., then) use the DL CSI estimate as input an AI/ML-based CSI generation function (e.g., encoder) and/or output a latent representation (e.g., a vector of real-valued latent variables). The WTRU may map the generated latent representation to UL REs, for example by bypassing one or more of quantization, FEC, and/or modulation. Bypassing the one or more of quantization, FEC, and/or modulation may refer to not (e.g., without) performing one or more of quantization, FEC, and/or modulation. The latent variables in the latent representation may not have fixed amplitudes, such that desired uplink power and/or SNR may not be achieved without scaling the latent variables. The WTRU may compute one or more scaling factors. The one or more scaling factors may be applied to the UL REs and/or the latent representations, for example such that the UL transmitted signal is normalized to unitary power. The WTRU may determine the one or more scaling factors based on one or more of a metric from the UL REs and/or the latent variables (e.g., max value, min value, average, average power, variance, etc.), a metric from the UL REs and/or latent variables assigned to the same OFDM symbol, a configured offset, a WTRU maximum UL transmit power, and/or UL/DL channel measurements. For example, the one or more scaling factors may be computed relative to a configured offset (e.g., received from the NW).

The WTRU may apply the scaling either before or after mapping the generated one or more latent representations to the UL REs. The WTRU may (e.g., then) transmit the mapped and scaled latent representation, for example along with the computed one or more scaling factors, to the NW. The WTRU may include the computed one or more scaling factors in the analog CSI feedback report, for example so that the NW may undo the scaling and/or recover the latent representation.

Systems and methods for scaling factor signaling from the WTRU to the NW are disclosed herein. The analog CSI feedback report allocation may include REs that are used to carry the scaling factor. For example, the analog CSI feedback report use one or more of which K REs carry the digitized one or more scaling factors, how to quantize them, and/or which FEC code and/or MCS to use, etc.

For example, K REs of the allocation may be used to carry one or more scaling factors in an analog format. For example if a single scaling factor is used to scale the entire set of latent variables of the latent representation and/or K=1 REs is configured to carry the scaling factor, the RE amplitude and/or phase may be controlled to indicate the scaling factor to the NW. In another example, UL RS (e.g., DMRS) phases may be manipulated in a predefined way to indicate the scaling factor.

Signaling of multiple scaling factors may be indicated and/or used (e.g., to normalize UL transmitted signal to unitary power on a per OFDM symbol basis, or on a per RE basis). For example, the NW may configure the WTRU to determine one scaling factor per OFDM symbol such that the target average power for the OFDM symbol is achieved and/or the max power over all the RE in each OFDM symbol is achieved, etc. The average UL SNR may be further improved, for example if the REs carrying the latent representation can be grouped by similarity of amplitude. For example, when the REs are of similar amplitude, the scaling factor may cause the SNR for each RE to be similar and near the target SNR. The NW may indicate a permutation of the mapping of latent representation to the real and imaginary parts of the REs in the UL allocation, for example after an initial observation period. The WTRU may be configured to indicate a permutation of the mapping of latent representation as part of the scaling factor signaling, for example for more dynamic support of changing latent representation variations.

The NW may receive the UL signals carrying the analog CSI feedback report and/or extract the latent representation and the one or more scaling factors. The NW may estimate the UL channel and/or apply equalization to the extracted latent representation, which for example may (e.g., now) include noise. The NW may (e.g., then) undo the scaling and/or recover the latent representation. The NW may (e.g., then) use the recovered latent representation as input to an AI/ML-based CSI reconstruction function (e.g., decoder), for example to reconstruct the DL CSI estimate. The NW may determine to feed the latent representation extracted from the analog CSI feedback report directly, for example without equalization to an AI/ML-based CSI reconstruction function.

Systems and method for AI/ML for channel state feedback (CSF) reporting are disclosed herein. The WTRU may be configured to use an AI/ML model for CSI feedback reporting. An AI/ML process may include stages including one or more of application, an input data, a preprocessing, an AI/ML model, an output data, and/or a training. Application may include CSI feedback reporting (e.g., CSI Compression). Input data may include a DL CSI estimate (e.g., full raw channel or eigenvectors of the raw channel). Preprocessing may include one or more of extracting the CSI-RS from the received signals by using the CSI-RS resource allocations, division by or multiplication by conjugate of the known CSI-RS symbols, applying an interpolation and/or a 2D filtering to the CSI-RS carrying REs, applying singular value decomposition (SVD) to estimated full DL raw channel (e.g., if the CSI feedback reporting is based on the eigenvectors of the estimated full DL raw channel), resizing the input data shape, and/or concatenation of the real and imaginary parts (e.g., to obtain the real-valued input to the AI/ML model).

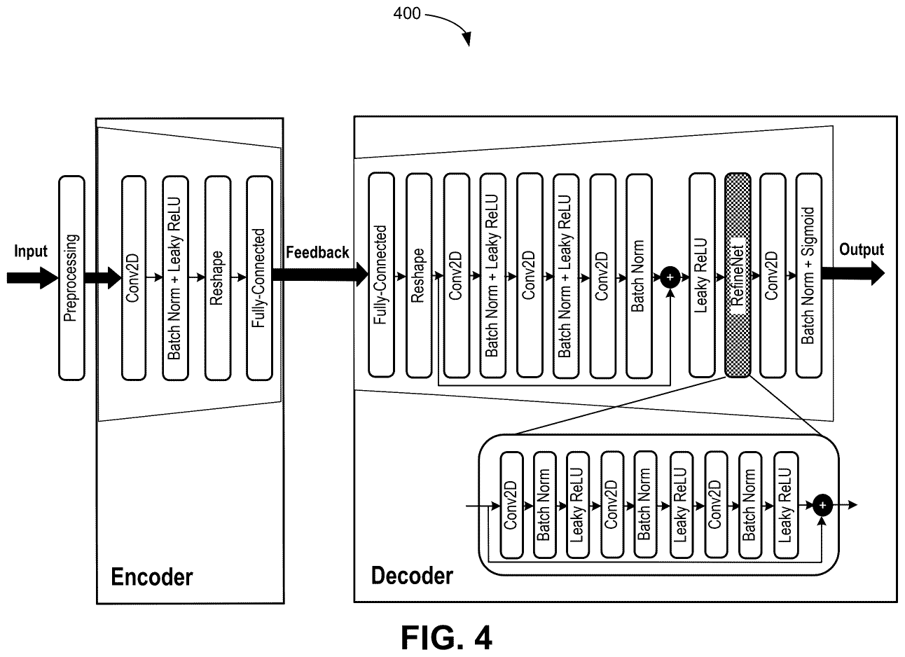

For the CSI feedback, various AI/ML models have been proposed in the literature for CSI compression including CsiNet, EVCsiNet, etc. AI/ML models for CSI compression may use an encoder at the WTRU to compress the DL CSI estimate (e.g., full raw channel or eigenvectors of the raw channel) into a low dimensional real-valued latent representation, for example based on the autoencoder architecture. The representation may be transmitted to the NW in the CSI feedback report. The AI/ML models may use a decoder at the NW to reconstruct the DL CSI estimate from the CSI feedback report. FIG. 4 is an example CsiNet model architecture 400. The CsiNet model architecture 400 may include one or more convolutional layers, batch normalization layers, leaky ReLU and Sigmoid activation layers, and/or residual connections.

The CsiNet model architecture 400 may generate an output. The output may include output data, for example including real and/or imaginary parts of reconstructed DL CSI estimate. Training (e.g., of the CsiNet model) may be performed either offline or online based on either intermediate KPIs or end-to-end KPIs as.

For AI/ML-based CSI feedback functions that use historical CSI at the WTRU and/or the NW (e.g., Spatial/Temporal/Frequency (STF) CSI compression, and/or joint CSI compression and prediction, etc.), the same AI/ML model architectures may be used, for example by adapting the input layer at the encoder to include the sequence of historical DL CSI estimates and/or the input layer at the decoder to include the historical reconstructed DL CSI estimates.

A WTRU that is configured to perform AI/ML-based analog CSI feedback reporting, may have parameters (e.g., key parameters) configured by the NW. The parameters may include one or more of DL RS (e.g., CSI-RS) resource allocation and/or CSI feedback reporting configuration. DL RS (e.g., CSI-RS) resource allocation may include one or more of RS periodicity, RS locations, and/or RS density, etc. A CSI feedback reporting configuration may include one or more of a reporting type (e.g., periodic, semi-persistent, and/or aperiodic), a report quantity (e.g., configuration of AI/ML-based analog CSI feedback report), a configuration of channel state feedback parameters (e.g., the number of CSI estimates used for CSI feedback reporting, etc.), the size of the analog CSI feedback report and/or the latent representation (e.g., number of latent variables per latent representation), UL MIMO layers that should carry the latent representations (e.g., if the WTRU is capable of multi-layer UL transmission), the signals and/or the uplink resource configuration/allocations that should carry the analog CSI feedback report (e.g., PUSCH, PUCCH, RRC, UCI, and/or MAC-CE, and/or one or more mechanisms for mapping (e.g., how to map) the latent representations and/or the scaling factors to the UL REs (e.g., a function that map the latent representations and the scaling factors to the UL REs). For example, a function may map the latent representations and the scaling factors to the UL REs. The function may be a learned function (e.g., an AI/ML-model).

Signaling for AI/ML-based analog CSI feedback reporting is disclosed herein. An analog CSI feedback report may be transmitted from the WTRU to the NW. The analog CSI feedback report may include the scaled and mapped latent representations generated by the WTRU and/or the one or more scaling factors computed by the WTRU. The WTRU may transmit the scaled and mapped latent representations to the NW dynamically through UCI.

The WTRU may use a mapping function to map the latent representations to the UL REs, for example for transmission of the scaled and mapped latent representations. The NW may determine the mapping function. The best (e.g., determined) mapping function may depend on one or more of UL SNR, hardware/radio impairments at the WTRU, and/or distribution (e.g., prior) of the one or more scaling factors, etc. The WTRU may indicate to the NW the WTRU's hardware/radio impairments. The NW may (e.g., then) select a mapping function based on a NW estimate of UL SNR. The mapping function can be learned (e.g., and AI/ML model).

An example of a non-AI/ML mapping function may include mapping M latent variables per UL RE. For example, the WTRU may map each M (e.g., M=1, 2, etc.) latent variables in each scaled real-valued latent representation to an UL RE. The WTRU may be triggered to use M=1 (e.g., one latent variable per UL RE), for example if the NW is experiencing low UL SNR (e.g., due to high pathloss, high interference, high hardware/radio impairments, etc.). The WTRU may be triggered to use M=2 (e.g., two latent variables per UL RE), for example if the NW is experiencing moderate and/or high UL SNR. The WTRU may generate a complex latent representation from the scaled real-valued latent representation. For example, each of two latent variables may be combined as the real-part and imaginary-part of a complex latent variable. The corresponding complex latent variable may be mapped to an UL RE.

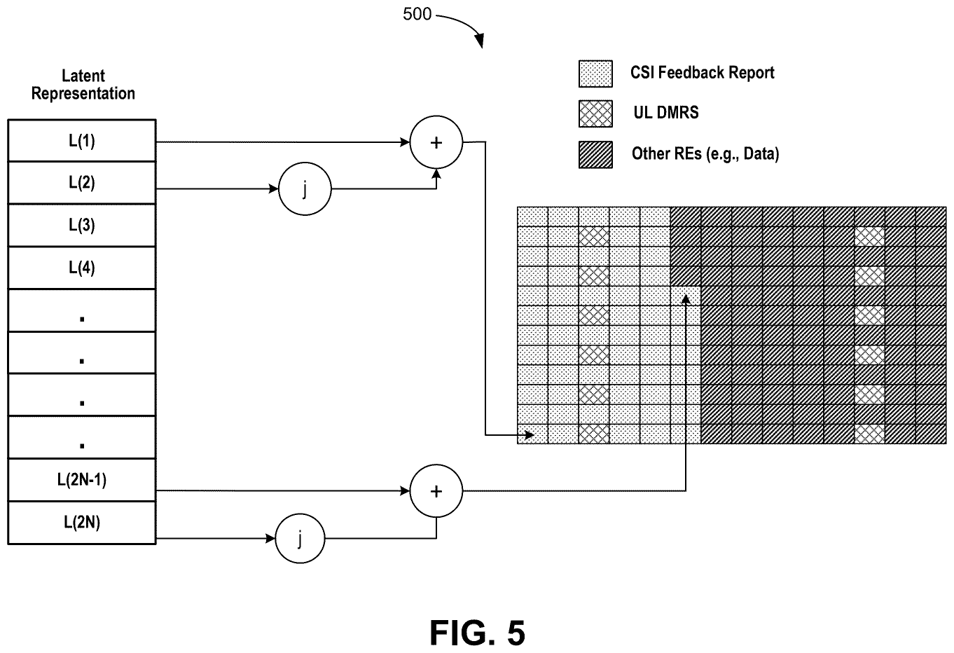

FIG. 5 is an example of an analog CSI feedback report mapping 500 to UL REs in a resource block. The analog CSI feedback report may include 2N=128 real-valued latent variables that are mapped to N=64 REs within one resource block (RB), where for example type 1 DMRS is adopted. N UL REs may be used to accommodate the transmission of an analog CSI feedback report with 2N real-valued latent variables from the WTRU to the NW.

Systems and methods for scaling factor signaling, for example from the WTRU to the NW, are disclosed herein. The analog CSI feedback report allocation may include REs that are used to carry the scaling factors. For example, the CSI feedback report may include K REs which may be used to carry the digitized one or more scaling factors, how to quantize them, and/or which FEC code and MCS to use, etc. For example K REs of the allocation may be used to carry one or more scaling factors in an analog format. For example if a single scaling factor is used to scale the entire set of latent variables of the latent representation and/or K=1 REs is configured to carry the scaling factor, the RE amplitude and/or phase may be controlled to indicate the scaling factor to the NW. In another example, the UL RS (e.g., UL DMRS) phases may be manipulated in a predefined way to indicate the scaling factor.

Signaling of multiple scaling factors may be indicated and/or used (e.g., to normalize UL transmitted signal to unitary power on a per OFDM symbol basis and/or on a per RE basis). For example, the NW may configure the WTRU to determine one scaling factor per OFDM symbol so that the target average power for the OFDM symbol is achieved and/or the max power over all the RE in each OFDM symbol is achieved. The average UL SNR may be further improved, for example if the REs carrying the latent representation can be grouped by similarity of amplitude. For example, when the REs are of similar amplitude the scaling factor may cause the SNR for each RE to be similar and/or near the target SNR. The NW may indicate a permutation of the mapping of latent representation to the real and imaginary parts of the REs in the UL allocation, for example after an initial observation period. The WTRU may be configured to indicate a permutation of the mapping of latent representation as part of the scaling factor signaling, for example for more dynamic support of changing latent representation variations.

The WTRU may employ an AI/ML model (e.g., received from the NW) to signal the scaling factors to the NW. For example, the WTRU may employ an AI/ML-model (e.g., encoder) to encode the scaling factors into a power-normalized latent representation. The WTRU may (e.g., then) transmit the resulting power-normalized latent representation to the NW in analog format.

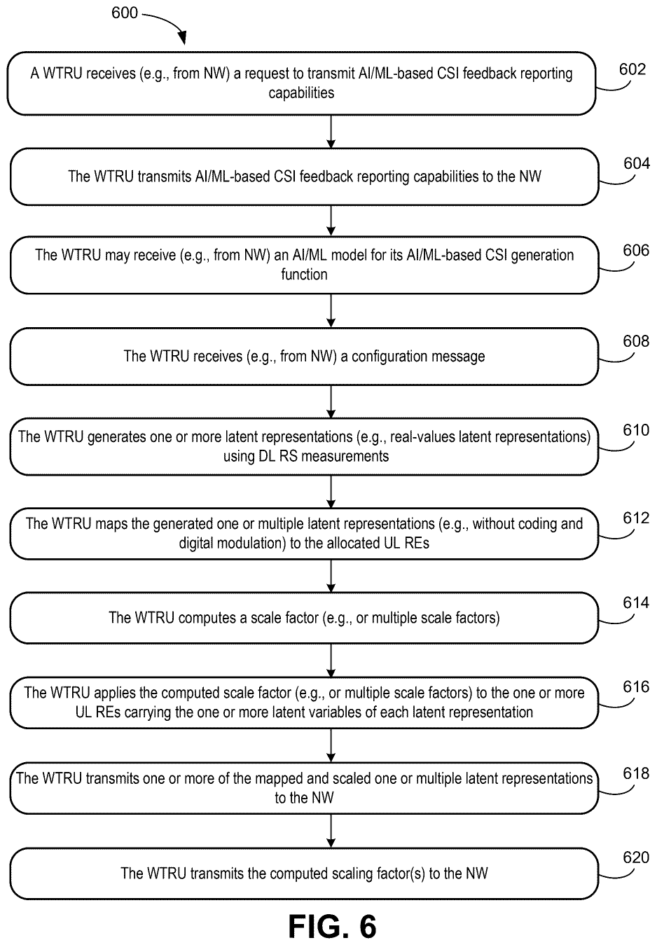

FIG. 6 is a flowchart depicting an example of WTRU AI/ML-based analog CSI feedback reporting 600. The NW may refer to any node in the network, for example one or more of a gNB, and/or another WTRU (e.g., Sidelink, WTRU-to-WTRU direct communication), etc. At 602 a WTRU may receive (e.g., from NW) a request to transmit AI/ML-based analog CSI feedback reporting capabilities. At 604 the WTRU may transmit WTRU's AI/ML-based analog CSI feedback reporting capabilities to the NW, for example in a capabilities message. The capabilities message may indicate one or more of WTRU support for AI/ML-based analog CSI feedback reporting and/or WTRU's hardware/radio impairments (e.g., phase noise characteristic, power amplifier characteristic, etc.). The WTRU may transmit its capabilities to the NW by RRC signaling.

At 606 the WTRU may receive (e.g., from NW) an AI/ML model for its AI/ML-based CSI generation function. At 608 the WTRU may receive (e.g., from NW) a configuration message, for example including configuration information). The configuration message (e.g., configuration information) may include one or more of a reporting type (e.g., periodic, semi-persistent, and/or aperiodic), a report quantity (e.g., configuration of AI/ML-based analog CSI feedback report), a configuration of channel state feedback parameters (e.g., the number of CSI estimates used for CSI feedback reporting, etc.), the size of the analog CSI feedback report and/or the latent representation (e.g., number of latent variables per latent representation), an indication of UL MIMO layers that should be used to transmit the latent representations (e.g., if the WTRU is capable of multi-layer UL transmission), an allocation(s) of the UL resources and/or the signals that should be used to transmit the analog CSI feedback report (e.g., REs pattern over the frequency and/or time domain), and/or one or more mechanisms for mapping (e.g., how to map) the latent representations and/or the scaling factors to the UL REs (e.g., a function that map the latent representations and the scaling factors to the UL REs). Additionally, or alternatively, the configuration message (e.g., configuration information) may include (e.g., an indication of) DL reference signals, for example DL reference signal measurement(s). The WTRU may receive the configuration message through one or more of DCI, MAC-CE, and/or RRC signaling.

At 610 the WTRU may generate one or more latent representations (e.g., real-valued latent representations), for example using DL RS measurements. For example, the WTRU may input one or more DL RS measurements to an AI/ML-based CSI generation function (e.g., of an AI/ML-based model) and/or generate one or more latent representations (e.g., using the AI/ML-based model).

At 612 the WTRU may map the generated one or more latent representations, for example without coding and/or digital modulation to the allocated UL REs. The WTRU may spread the UL REs carrying the one or more latent representations following a specific pattern. The pattern may be configured by the NW and/or determined by the WTRU. The WTRU may indicate to the NW the REs carrying the one or more latent representations.

At 614 the WTRU may compute one or more scaling factors. The one or more scaling factors may be (e.g., later) applied to the one or more UL REs, for example carrying the one or more latent variables of each latent representation. The WTRU may determine the one or more scaling factors based on one or more of a metric from the one or more UL REs or latent variables (e.g., max value, min value, average, average power, variance, etc.), a metric from one or more UL REs or latent variables assigned to the same OFDM symbol, a configured offset, the WTRU UL transmit power, and/or UL/DL channel measurements. For example, the one or more scaling factors may be computed relative to a configured offset (e.g., received from the NW). Additionally, or alternatively, the WTRU may determine the one or more scaling factors based on at least one of the measured uplink channel reference signal and/or the measured downlink channel reference signal.

At 616 the WTRU may apply the one or more scaling factors to the one or more UL REs, for example carrying the one or more latent variables of each latent representation. The WTRU may apply the scaling either before or after mapping the generated one or more latent representations to the allocated UL REs. At 618 the WTRU may transmit one or more of the mapped and scaled latent representations to the NW. At 620 the WTRU may transmit the computed one or more scaling factors to the NW. The WTRU may transmit the computed one or more scaling factors to the NW by one or more of a digital transmission (e.g., with FEC and modulation), an analog transmission, and/or manipulation of UL RS (e.g., DMRS).

The NW may transmit an AI/ML-based analog CSI feedback reporting capabilities request to the WTRU. The NW may receive the AI/ML-based analog CSI feedback reporting capabilities from the WTRU. The NW may determine and/or transmit the appropriate AI/ML model for the AI/ML-based CSI generation function to the WTRU. The NW may transmit a configuration message to the WTRU. The NW may receive the UL signals carrying the analog CSI feedback report. The NW may extract the one or more latent representations from the received analog CSI feedback report. The NW may perform channel estimation and/or apply equalization to the extracted one or more latent representations.

The NW may extract the one or more scaling factors from the received analog CSI feedback report. The NW may undo the scaling and/or recover the one or more latent representations. The NW may use the recovered one or more latent representations as input to an AI/ML-based CSI reconstruction function and/or generate a NW-side reconstructed DL CSI estimate.

Example numerical results are disclosed herein. For example, simulation parameters are disclosed. Numerical results may be presented for the performance evaluation of the proposed AI/ML-based analog CSI feedback reporting. Simulations may be performed using Sionna, which is an open-source Python library for the link-level simulations based on TensorFlow. Example simulation parameters are presented in Table 1.

TABLE 1

| Number of Antenna at gNB | 16 | |
|---|---|---|
| Number of Antenna at WTRU | 2 | |
| Number of Layers L | 2 | |
| DL/UL Duplex Mode | FDD | |
| Carrier Frequency DL | 2.1 | GHz |
| Carrier Frequency UL | 1.9 | GHz |
| Subcarrier Spacing | 15 | kHz |
| Number of Subcarriers DL | 612 | |
| Bandwidth DL | 10 | MHz |
| Number of Subcarriers UL | 24 | |
| Channel Model | CDL-C | |
| WTRU Velocity | 60 | Km/h |
| Delay Spread | 300 | ns |
| CSI Type | Full raw channel | |
| CSI-RS periodicity | 5 | ms |

| | |
|---|---|
| DL SNR (training and | [−10 dB, 15 dB] |
| inference) | |
| UL SNR (training and | [−5 dB, 5 dB] |
| inference) | |

An example use case to evaluate the proposed AI/ML-based analog CSI feedback reporting may include spatial/temporal/frequency (STF) CSI compression. Table 2 shows example cases considered for STF CSI compression.

TABLE 2

| | Target | Whether the | Whether the network |
|---|---|---|---|
| | CSI | WTRU uses past CSI | uses past CSI |
| Case | slot(s) | information | information |
| 0 | Present | No | No |
| | slot | | |
| 1 | Present | Yes | No |
| | slot | | |
| 2 | Present | Yes | Yes |
| | slot | | |
| 3 | Future | Yes | No |
| | slot(s) | | |
| 4 | Future | Yes | Yes |
| | slot(s) | | |
| 5 | Present | No | Yes |
| | slot | | |

An example STF CSI compression use case is considered herein to evaluate the proposed AI/ML-based analog CSI feedback reporting. For example, case 2 and case 4 in Table 2 may be selected for this purpose. Table 3 details an example solution and baseline.

TABLE 3

| | CSI | |
|---|---|---|
| | Feedback | |
| | Report | |
| Technique | Overhead | AI/ML Model Complexity |
| Proposed 1: AI/ML-based analog CSI feedback | 256 REs | Number of Parameters: |
| reporting with 512 real-valued latent variables | | 3422K |
| per latent representation. | | FLOPs: 169.17M |
| Proposed 2: AI/ML-based analog CSI feedback | 64 REs | Number of Parameters: |
| reporting with 128 real-valued latent variables | | 865K |
| per latent representation. | | FLOPs: 164M |
| Baseline: AI/ML-based digital CSI feedback | 256 REs | Number of Parameters: |
| reporting with 128 real-valued latent variables | | 865K |
| per latent representation. This baseline is | | FLOPs: 164M |
| adopted in 3GPP RAN WG1. Moreover, the | | |
| WTRU applies a 2 bits/element quantization to | | |
| the latent representation. Furthermore, the | | |
| WTRU applies MCS of legacy non-AI/ML CSI | | |
| feedback reporting to the latent representation, | | |
| which is polar coding with 1/2 code rate and | | |
| QPSK modulation, to the latent representation | | |
| prior to UL transmission to the NW. | | |

AI/ML models for the proposed and baseline solutions may be trained with CSI data, for example generated on the fly for 50 independent runs. Each run may include 400 consecutive time slots and/or a batch of 300 raw channel matrices per time slot. The results may be generated based on CSI data generated on the fly for 1 run consisting of 400 consecutive time slots, and a batch of 300 raw channel matrices per time slot. The number of historical CSI samples at the WTRU and the NW may be 4 CSI estimates. This number of historical CSI samples and the WTRU and the NW may be different from the actual CSI estimate. The number of future CSI samples for case 4 STF CSI compression (e.g., with prediction) may be 1 CSI estimate.

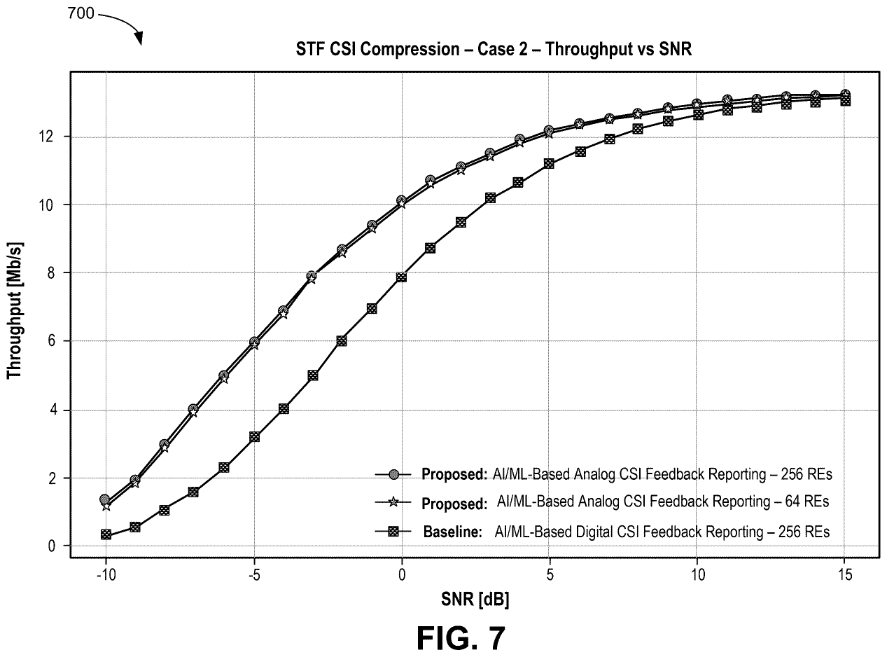

FIG. 7 is a plot of example throughput performance 700 of analog CSI feedback reporting for case 2 spatial/temporal/frequency (STF) CSI compression. For example, for case 2 STF CSI compression (e.g., STF CSI compression without prediction), FIG. 7 may present the throughput performance versus signal-to-noise-ratio (SNR) for the proposed solution and the baseline (e.g., as in Table 3) for case 2 (e.g., in Table 2) of the STF compression use case. FIG. 7 shows significant gain resulting from the proposed AI/ML-based analog CSI feedback reporting solutions, for example compared to the AI/ML-based digital CSI feedback reporting baseline.

For a target throughput of 8 Mbps, a proposed AI/ML-based analog CSI feedback reporting solution with 512 latent variables per latent representations may provide 3.2 dB SNR gain compared to the AI/ML-based digital CSI feedback reporting baseline for the same CSI feedback report overhead (e.g., 256 REs), for example at the expense of higher AI/ML models complexity. The proposed AI/ML-based analog CSI feedback reporting solution with 128 latent variables per latent representations may provide 3.2 dB SNR gain compared to the AI/ML-based digital CSI feedback reporting baseline for the same AI/ML model complexity, for example with 75% overhead reduction (e.g., 64 REs instead of 256 REs). The proposed AI/ML-based analog CSI feedback reporting solution may provide higher performance/complexity/overhead tradeoff, for example based on these observations.

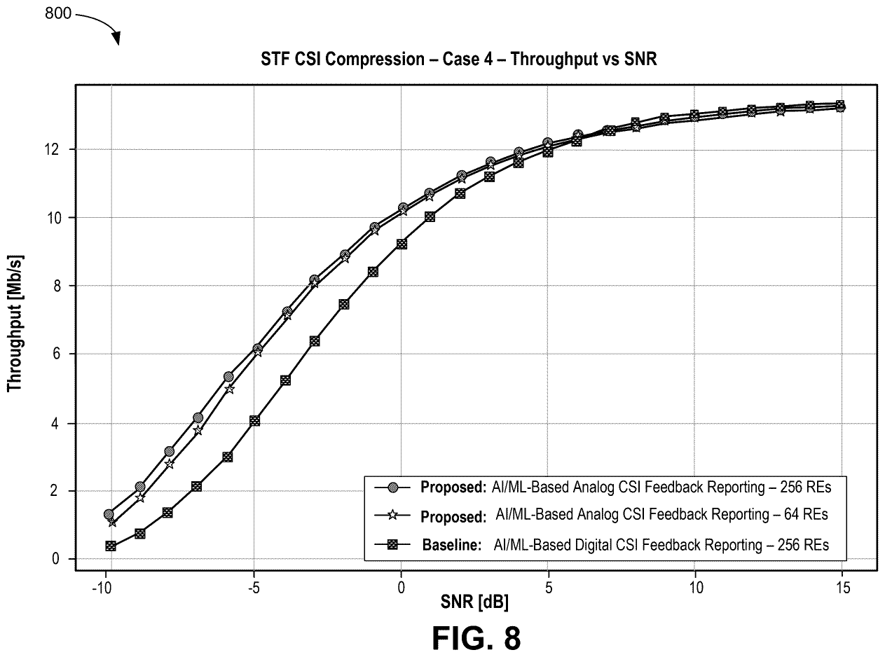

FIG. 8 is a plot of example throughput performance 800 of analog CSI feedback reporting for case 4 STF CSI compression. For example, for case 4 STF CSI compression (e.g., STF CSI compression with prediction), FIG. 8 may present the throughput performance versus signal-to-noise-ratio (SNR) for the proposed solution and the baseline (e.g., as in Table 3) for case 4 (e.g., as in Table 2) of the STF compression use case. FIG. 8 shows the significant gain resulting from the proposed AI/ML-based analog CSI feedback reporting solutions compared to the AI/ML-based digital CSI feedback reporting baseline.

For a target throughput of 8 Mbps, a proposed AI/ML-based analog CSI feedback reporting solution with 512 latent variables per latent representations may provide 1.8 dB SNR gain compared to the AI/ML-based digital CSI feedback reporting baseline for the same CSI feedback report overhead (e.g., 256 REs), for example at the expense of higher AI/ML models complexity. The proposed AI/ML-based analog CSI feedback reporting solution with 128 latent variables per latent representations may provide 1.4 dB SNR gain compared to the AI/ML-based digital CSI feedback reporting baseline for the same AI/ML model complexity, for example with 75% overhead reduction (e.g., 64 REs instead of 256 REs). The proposed AI/ML-based analog CSI feedback reporting solution may provide higher performance/complexity/overhead tradeoff, for example based on these observations.

1. A wireless transmit/receive unit (WTRU) comprising:
a processor configured to:
determine an artificial intelligence/machine learning (AI/ML) model that is associated with a channel state information (CSI) feedback function;
receive configuration information, the configuration information comprising an indication of downlink reference signals;
generate one or more latent representations using the AI/ML model and based on the downlink reference signals;
map the one or more latent representations to uplink resource elements (REs) without performing quantization, forward error correction, and modulation;
determine one or more scaling factors;
apply the determined one or more scaling factors to the one or more uplink REs mapped to the one or more latent representations to scale the latent representations;
transmit one or more of the one or more mapped and scaled latent representations; and
transmit the determined one or more scaling factors.

2. The WTRU of claim 1, wherein the one or more latent representations comprises one or more respective latent variables.

3. The WTRU of claim 1, wherein the configuration information comprises an indication of a number of latent variables for each latent representation.

4. The WTRU of claim 1, wherein the processor is configured to map the one or more scaling factors to the uplink REs.

5. The WTRU of claim 1, wherein the processor is configured to:
receive an indication of an offset from a network; and
determine the one or more scaling factors relative to the offset.

6. The WTRU of claim 1, wherein the processor is configured to:
determine a value associated with the one or more uplink REs, wherein the value comprises a maximum value, a minimum value, an average value, an average power value, or a variance value; and
determine the one or more scaling factors based on the value associated with the one or more uplink REs.

7. The WTRU of claim 1, wherein the processor is configured to:
determine a power associated with the uplink REs mapped to the one or more latent representations; and
determine the one or more scaling factors based on the power for normalizing an uplink transmitted signal to unitary power.

8. The WTRU of claim 1, wherein the processor is configured to:
measure at least one of an uplink channel reference signal or a downlink channel reference signal; and
determine the one or more scaling factors based on at least one of the measured uplink channel reference signal or the measured downlink channel reference signal.

9. The WTRU of claim 1, wherein the processor is configured to:
determine a pattern comprising an indication of uplink RE mapping; and
map the one or more latent representations to the one or more uplink REs based on the indication of uplink RE mapping.

10. The WTRU of claim 1, wherein the processor is configured to:
receive a message from a network requesting an indication of an AI/ML capability associated with CSI feedback; and
transmit a message to the network indicating the indication of the AI/ML capability of the WTRU associated with CSI feedback.

11. A method performed by a wireless transmit/receive unit (WTRU), the method comprising:
determining an artificial intelligence/machine learning (AI/ML) model that is associated with a channel state information (CSI) feedback function;
receiving configuration information, the configuration information comprising an indication of downlink reference signals;
generating one or more latent representations using the AI/ML model and based on the downlink reference signals;
mapping the one or more latent representations to uplink resource elements (REs) without performing quantization, forward error correction, and modulation;
determining one or more scaling factors;
applying the determined one or more scaling factors to the one or more uplink REs mapped to the one or more latent representations to scale the latent representations;
transmitting one or more of the one or more mapped and scaled latent representations; and
transmitting the determined one or more scaling factors.

12. The method of claim 11, wherein the one or more latent representations comprises one or more respective latent variables.

13. The method of claim 11, wherein the configuration information comprises an indication of a number of latent variables for each latent representation.

14. The method of claim 11, further comprising mapping the one or more scaling factors to the uplink REs.

15. The method of claim 11, further comprising:
receiving an indication of an offset from a network; and
determining the one or more scaling factors relative to the offset.

16. The method of claim 11, further comprising:
determining a value associated with the one or more uplink REs, wherein the value comprises a maximum value, a minimum value, an average value, an average power value, or a variance value; and
determining the one or more scaling factors based on the value associated with the one or more uplink REs.

17. The method of claim 11, further comprising:
determining a power associated with the uplink REs mapped to the one or more latent representations; and
determining the one or more scaling factors based on the power for normalizing an uplink transmitted signal to unitary power.

18. The method of claim 11, further comprising:
measuring at least one of an uplink channel reference signal or a downlink channel reference signal; and
determining the one or more scaling factors based on at least one of the measured uplink channel reference signal or the measured downlink channel reference signal.

19. The method of claim 11, further comprising:
determining a pattern comprising an indication of uplink RE mapping; and
mapping the one or more latent representations to the one or more uplink REs based on the indication of uplink RE mapping.

20. The method of claim 11, further comprising:
receiving a message from a network requesting an indication of an AI/ML capability associated with CSI feedback; and
transmitting a message to the network indicating the indication of the AI/ML capability of the WTRU associated with CSI feedback.
